(19) United States
(12) Patent Application Publication
(10) Pub. No.: US 2003/0088551 A1
(43) Pub. Date: May 8, 2003

(54) Method and system for searching for drawing numbers

(76) Inventor: Wei Tong, Clifton Park, NY (US)

Correspondence Address: PERKINS COIE LLP, PATENT-SEA, P.O. BOX 1247, SEATTLE, WA, 98111-1247, US

(21) Appl. No.: 10/039,763

(22) Filed: Nov. 7, 2001

(51) Int. Cl. G06F 7/00

(52) U.S. Cl. 707/3

(57) ABSTRACT

A method and system for searching for drawing numbers related to a device, such as a generator. The drawing number search system receives information relating to a generator, which may include the cooling method of the generator and either a generator type or a shop order identification. The system also receives a part name or other identification. When the information has been received, the drawing number search system accesses a database and determines the drawing number associated with the generator and the part name. The system then transmits the results to a user. The drawing number search system may be implemented in a client/server environment, such as a web-based environment over the Internet or an intranet. In such an environment, a web server provides the various components of the drawing number search system.

### BACKGROUND OF THE INVENTION

The described technology relates generally to computer-based drawing number systems and, in particular, to drawing number search systems.

In many businesses, there is the need to have documents, particularly technical and/or mechanical drawings, available for access over an extended period of time. For example, a power plant may have equipment that has a lifetime of 20 to 40 years. During its lifetime, the equipment may need to be maintained or upgraded. It is important to have the drawings depicting the equipment available in order to properly maintain and upgrade that equipment. If such drawings are not available, the maintenance or upgrade may only be possible by estimating or measuring the characteristics or dimensions of the equipment. In some instances, it may not even be possible to maintain or upgrade the equipment if the drawings are not available. Thus, if the drawings are not available, then the cost of operating the equipment may increase dramatically or the equipment may become useless. To help ensure that drawings are available, many companies use a unique drawing number to identify each drawing so that it can be readily identified and located.

A modern power generator may contain thousands or tens of thousands of parts. Such a generator may be divided into a set of components, such as a frame, instrumentation, rotor, stator, etc. Each component may be then divided into sections, and each component and section is composed of one or more parts. Each part may have one or more drawings, and thus drawing numbers, associated with it. Multiple drawings may be necessary for a part because of different assemblies, installations, and instructions that are possible for each part. When an engineer or designer wishes to analyze, replace, or order a new part, they must find the appropriate drawings for the part. Thus, as a necessary step, it is important to find the drawing numbers efficiently and accurately.

Current drawing number systems provide a simplistic tool for finding drawing numbers. These existing systems do not include search capability and instead require the user to know either the exact drawing number or the precise location of the part in the system. For generator systems with thousands of parts, searching for a particular drawing could take a very long time, resulting in a negative impact in the employees' productivity and the company's efficiency. Statistical data has shown that searching for a drawing may take five minutes for an experienced draftsperson or engineer and hours or even days for newer employees who do not intimately know the generator systems. This process is labor-intensive, time-consuming, and prone to error.

It would be desirable to have a drawing number search system that would provide drawing number search capability, particularly in the context of complicated systems such as generators, and reduce the time needed to find a drawing.

### BRIEF DESCRIPTION OF THE DRAWINGS

FIG. 1 is a display page illustrating a main display page in one embodiment.

FIG. 2 is a display page used to collect information about the type of cooling method associated with a generator in one embodiment.

FIG. 3 is a display page used to collect information about the location of the part associated with a drawing number in one embodiment.

FIG. 4 is a block diagram that illustrates components of the drawing number search system in one embodiment.

FIG. 5 is a display page that illustrates the organizational structure of generator types in one embodiment.

FIG. 6 is a display page that illustrates the organizational structure of generator parts and components in one embodiment.

FIG. 7 is a block diagram that illustrates components of the drawing number search system and user computers in one embodiment.

FIG. 8 illustrates a database schema for the drawing number search system in one embodiment.

FIG. 9 is flow diagram illustrating a request to search by generator type in one embodiment.

FIG. 10 is a flow diagram illustrating the processing of a request to search by generator type in one embodiment.

FIG. 11 is flow diagram illustrating a request to search by shop order identification in one embodiment.

FIG. 12 is a flow diagram illustrating the processing of a request to search by shop order identification in one embodiment.

### DETAILED DESCRIPTION

A method and system for searching for drawing numbers is provided. In one embodiment, in order to find a drawing number for a part of a generator, the system initially receives an indication of a cooling method (e.g., air-cooling, hydrogen-cooling, etc.) for the generator from a user on a user computer. The system then receives a part name (e.g., excitor, frame flange, etc.) and a generator type (e.g., 5A3, 6A3, etc.) from the user. The system may then search a database for the drawing number associated with the part name and the generator type for generators with that cooling method. When the drawing number is found, the system generates a results display page and transmits the generated page to the requesting computer for display.

Using this method and system, a user can quickly and efficiently find a drawing number for a part of a generator. The generator type and cooling method will be well known, and the part name will be known, as it is what the user is seeking. Accordingly, a user can find a drawing number for a part of a generator in three minutes or less, compared to the much lengthier times needed in prior art systems. Moreover, the user does not need a deep knowledge of the generator design in order to find the drawing number, and instead only needs the generator information (generator type and cooling method) and the part name.

In another embodiment, in order to find a drawing number for a part of a generator, the system initially receives an indication of a cooling method for the generator from a user on a user computer. The system then receives a part name and a shop order identification (e.g., 337X184). A shop order identification typically represents a custom generator. The system may then search a database for the drawing number associated with the part name and the shop order identification for generators with that cooling method. When the drawing number is found, the system generates a results display page and transmits the generated page to the requesting computer for display. The shop order identification should be known to the user, making this embodiment also a quick and efficient method and system for finding a drawing number for a part of a generator.

The example drawing number search system relates to drawing numbers associated with parts and components of a generator, such as a turbine used to generate power. One skilled in the art will, however, appreciate that the drawing number search system may be used to search for drawing numbers related to virtually any item, such as mechanical devices, computer equipment, manufactured devices, vehicles, etc.

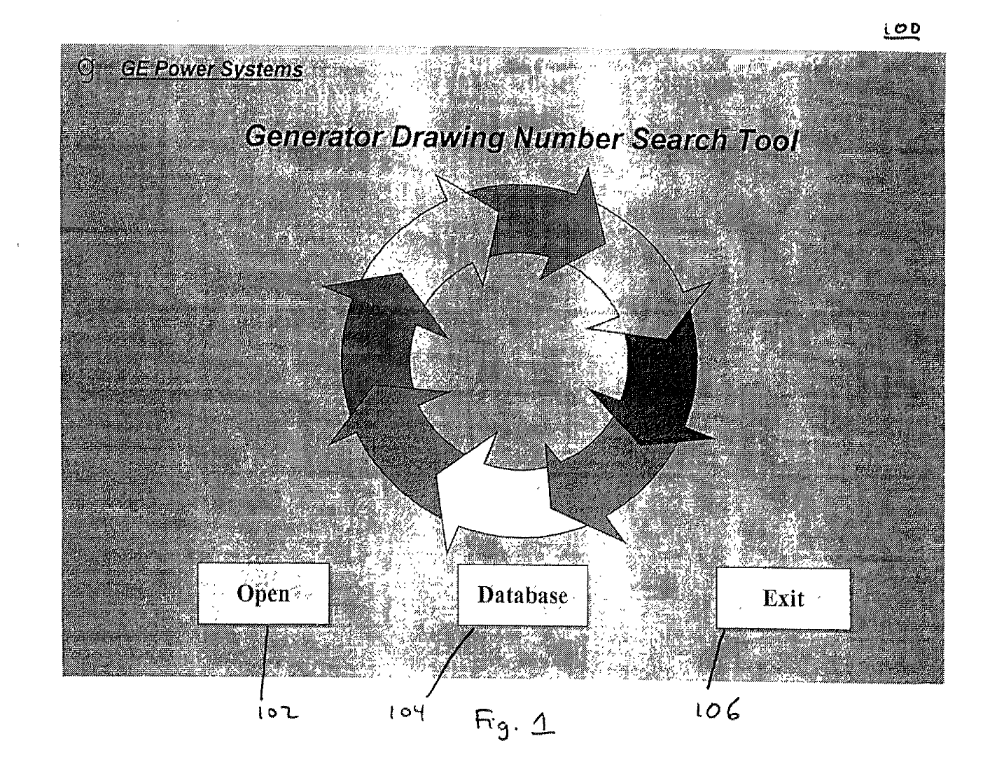

FIGS. 1-3 illustrate sample display pages of a drawing number search system in one embodiment. FIG. 1 is a display page illustrating a main display page in one embodiment. Main display page 100 includes an open button 102, a database button 104, and an exit button 106. The open button allows users to access the drawing number search functionality of the drawing number search system. The database button allows a user to access administrative functions, such as adding or deleting users, modifying or adding to the database of drawing numbers, etc. The database button may optionally be restricted by a user identification and/or password to prevent unauthorized access to sensitive parts of the drawing number search system. The exit button allows a user to exit the drawing number search system.

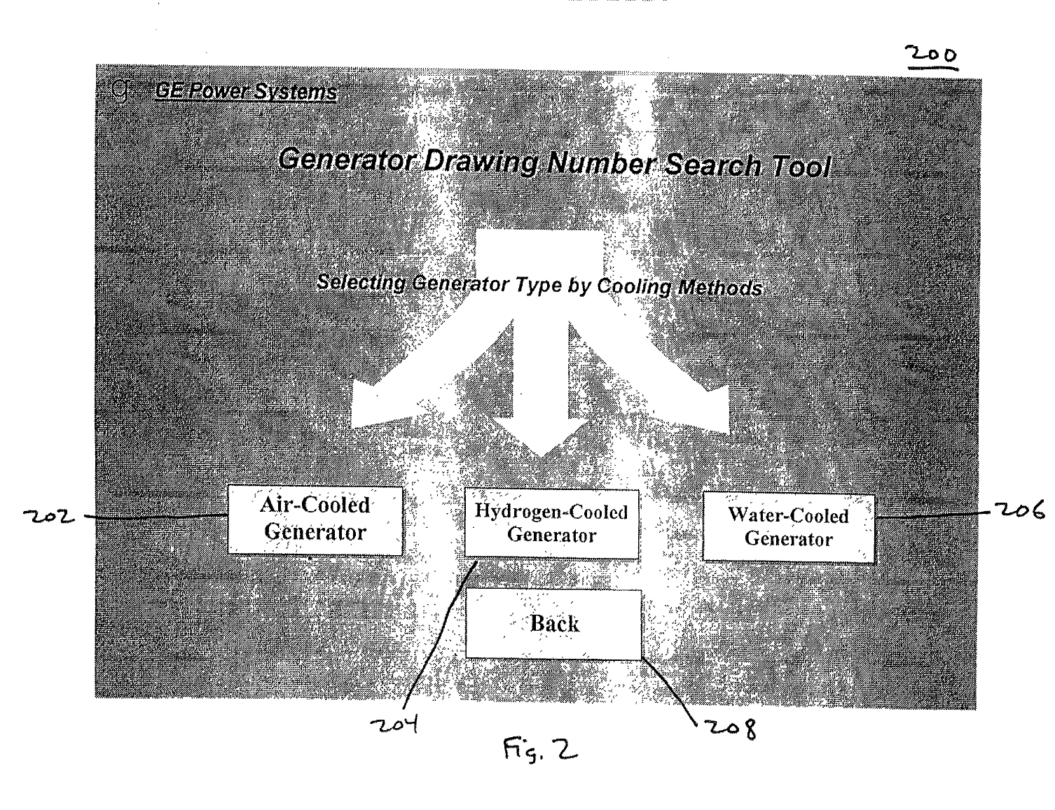

FIG. 2 is a display page used to collect information about the type of cooling method associated with a generator in one embodiment. The cooling method page 200 allows a user to select the type of cooling method associated with the generator for which they are searching for drawing numbers. A user may activate the cooling method page by selecting the open button on the main display page. The cooling method page in the depicted embodiment includes an air-cooled button 202, a hydrogen-cooled button 204, a water-cooled button 206, and a back button 208. The air-cooled button restricts the drawing number search to air-cooled generators, the hyrdrogen-cooled button restricts the search to hydrogen-cooled generators, and the water-cooled button restricts the search to water-cooled generators. The back button returns the user to the main display page described in relation to FIG. 1. One skilled in the art will recognize that the cooling method page is optional and that other methods of limiting a search are possible, such as having a user select a particular generator, a part type, drawings limited by date or size, etc.

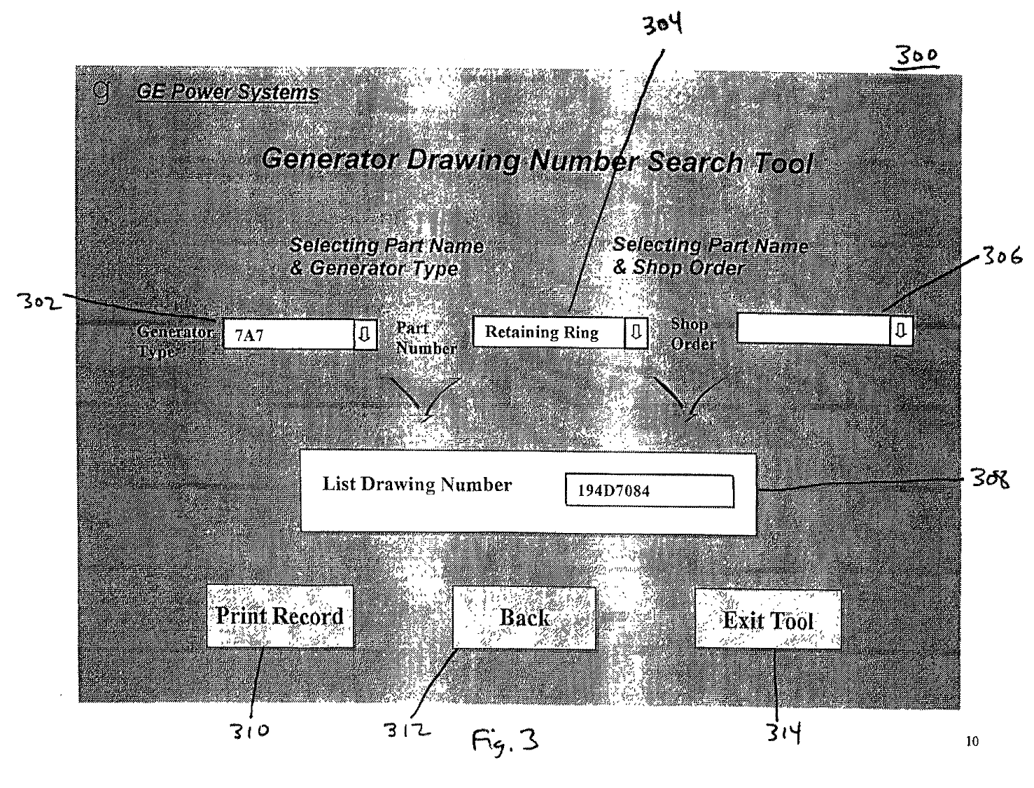

FIG. 3 is a display page used to collect information about the location of the part associated with a drawing number that is being searched for in one embodiment. Search page 300 may be activated when a user selects the air-cooled button, the hydrogen-cooled button, or the water-cooled button on the cooling method page. The search page 300 includes, in the depicted embodiment, a generator type field 302, a part field 304, a shop order field 306, a drawing number box 308, a print button 310, a back button 312, and an exit tool button 314. The generator type field is a pull-down list that allows a user to select a generator type from a list of generator types in the drawing number search system. The generator types included in the pull-down list are restricted to those than can employ the cooling method selected by the user. The part field is a pull-down list that allows a user to select a part from a list of parts in the drawing number search system. The shop order field is a pull-down list that allows a user to select a shop order identification from a list of shop order identifications in the drawing number search system. The shop order identifications may be model numbers or other identifications of individual, limited-run or customized generator designs. The custom generator may be a modified version of a generator type (e.g., a shop order identification may identify a slightly modified standard generator type customized for a particular customer). The shop order identification, like the generator type, is a way of identifying a particular generator. The shop order identifciations included in the pull-down list are restricted to those that can employ the cooling method selected by the user.

The drawing number box displays the results of the drawing number search. In the depicted embodiment, a drawing number may be found in a search when the part field and either the generator type field or the shop order field have been entered. In one embodiment, the drawing number search system may automatically start the search when an entry has been made in the part field and one of these other two fields. The generator type field and the shop order field may be used to identify the particular generator or generator type at issue, which, when combined with the particular part from the part field, provides enough information for the drawing number search system to determine the appropriate drawing number. One skilled in the art will recognize that many combinations of types of information are possible for requesting and identifying individual drawing numbers. For example, in one embodiment a part name and a date of production may be used to determine the appropriate drawing number.

In the depicted embodiment, the generator type is a type or model of generator, for which there may be tens or even hundreds existing. The shop order identification, on the other hand, typically represents a custom or limited production generator. The custom generator may be a modified version of a generator type (e.g., a shop order identification may identify a slightly modified standard generator type customized for a particular customer). Both generator types and shop order identifications are generator identifications, or ways of identifying a particular generator.

The print button of the search page allows a user to print a copy of the displayed screen or simply the results depicted in the drawing number box. The back button may take the user back to the cooling method page described in relation to FIG. 2, while the exit button will terminate the drawing number search system.

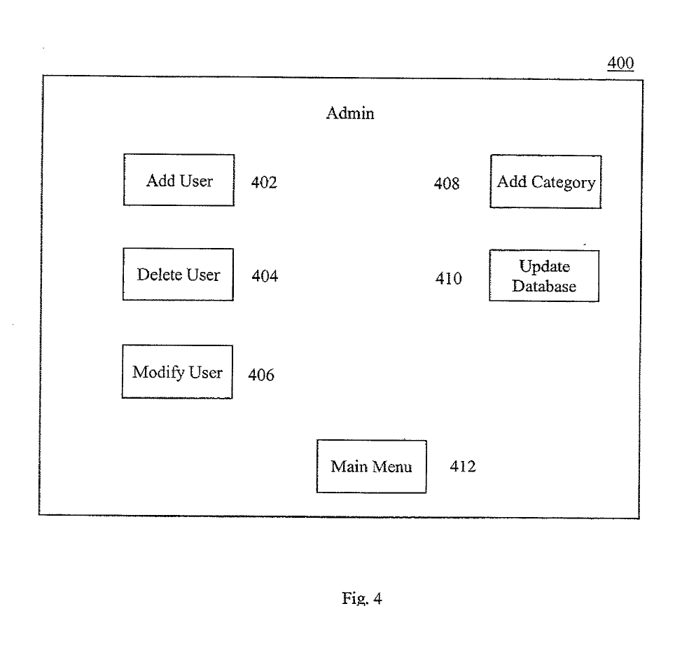

FIG. 4 is a display page used to perform administrative tasks of the drawing number search system in one embodiment. Admin page 400 may be activated when a user selects the database button on the main display page. In one embodiment, a password or other authentication procedure may be required to access the admin page. The admin page includes, in the depicted embodiment, an add user button 402, a delete user button 404, a modify user button 406, an add category button 408, an update database button 410, and a main menu button 412. The add user button, delete user button, and modify user button allow users of the system to be added, deleted, or modified, respectively. The add category button may be used by an administrator to add new generator types, parts field entries, or shop order identifications. The update database button may be used to by an administrator to update or modify the database of drawing numbers, as well as the information relating to the drawing numbers (e.g., associated generator type, part name or number, etc.). The main menu button simply returns the administrator to the main menu display page.

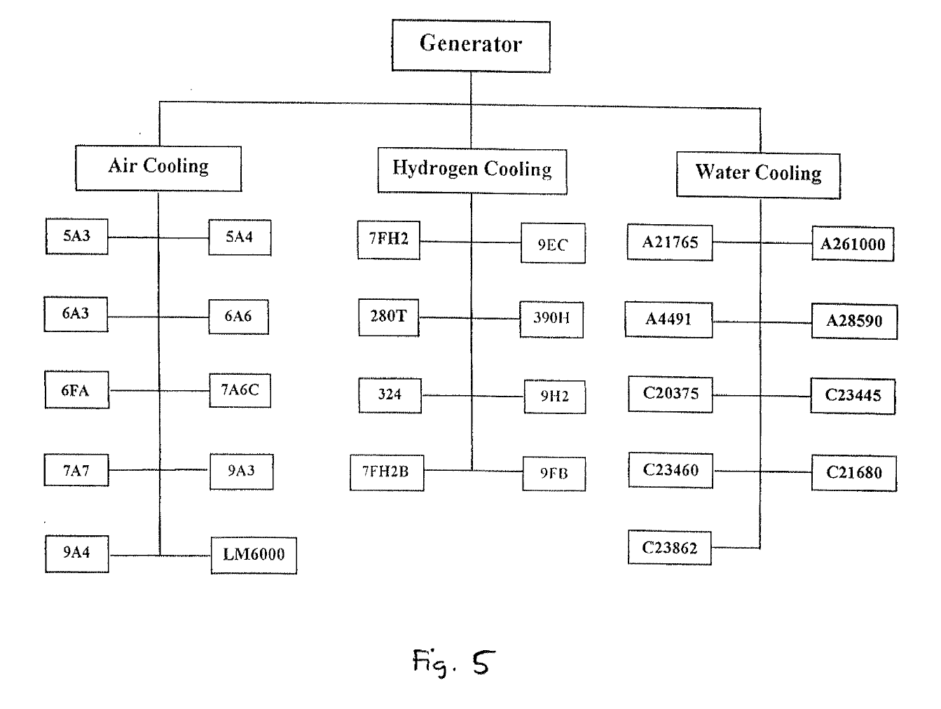

FIG. 5 is a display page that illustrates the organizational structure of generator types in one embodiment. FIG. 5 illustrates three main types of cooling methods for generators: air cooling, hydrogen cooling, and water cooling. For each type of cooling method, there are a number of different model numbers (or generator types) associated with generators using that cooling method. For example, air-cooled generators include the 5A3 generators, the 6A3 generators, the 6FA generators, etc. One skilled in the art will recognize that a virtually infinite amount of alternatives are possible for naming generators and all are within the scope of the present invention.

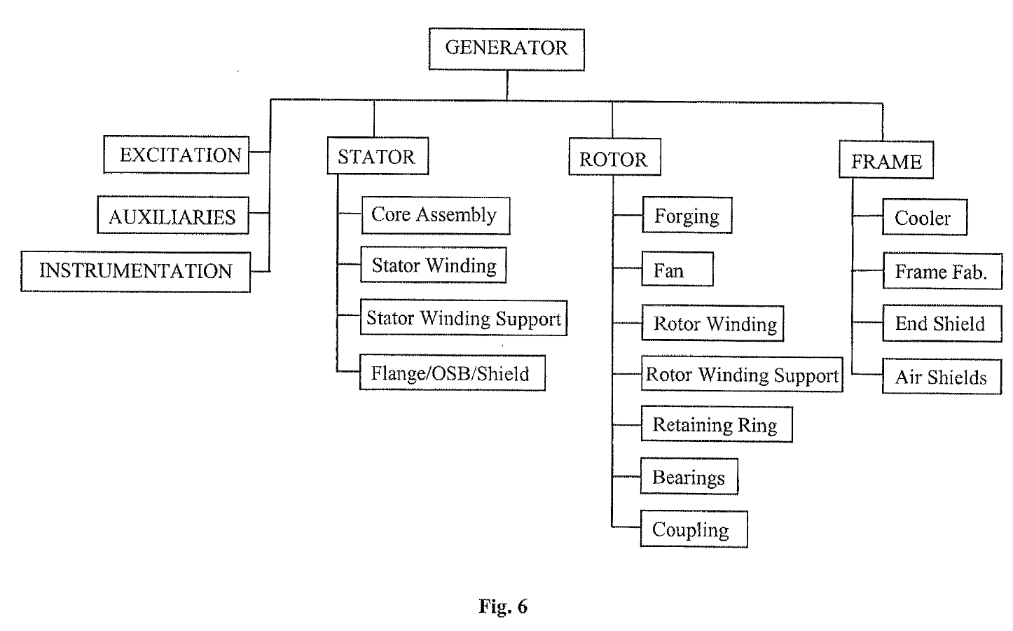

FIG. 6 is a display page that illustrates the organizational structure of generator components in one embodiment. As shown in FIG. 6, the typical generator includes a number of components, such as an excitation component, a stator, a rotor, a frame, instrumentation, and auxiliaries, as well as other components. Each component may have one or more sections that each comprises part of the component. For example, the stator includes a core assembly section, a stator winding section, a stator winding support section, a flange/OSB/shield section, etc. The components and sections are composed of one or more parts, and some components or sections may have hundreds or even thousands of parts. One skilled in the art will recognize that many configuration and design possibilities for components, sections, and other parts of a generator are possible and within the scope of the invention.

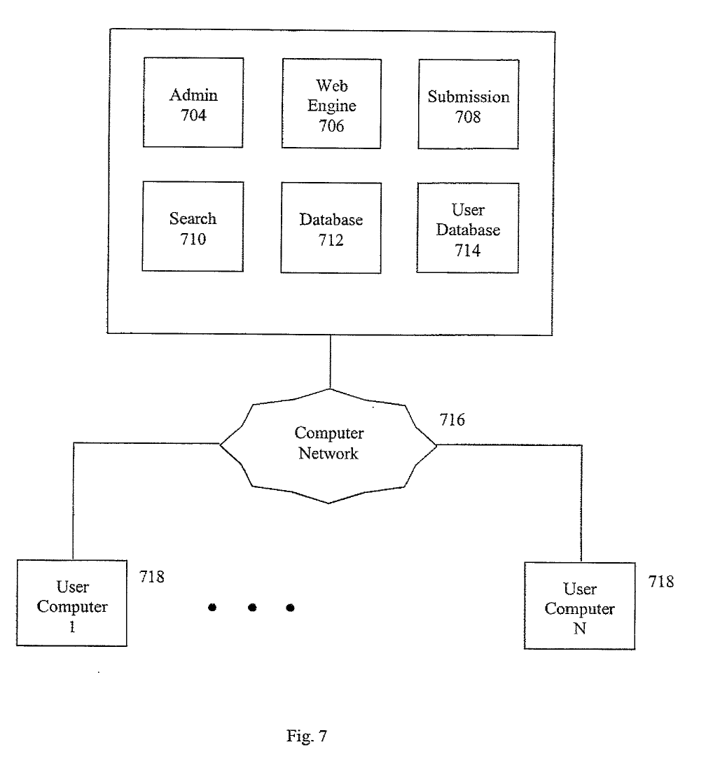

FIG. 7 is a block diagram that illustrates components of the drawing number search system and user computers in one embodiment. The drawing number search server 702 and one or more user computers 718 are interconnected via a computer network 716, such as the Internet or an intranet. The computers may include a central processing unit, memory, input devices (e.g., keyboard and pointing device), output devices (e.g., display devices), and storage devices (e.g., a hard drive, a CD-ROM, a floppy disk drive, etc.). The memory and storage devices are computer-readable media that may contain instructions for implementing the drawing number search system. In addition, the data structures and message structures may be stored or transmitted via a data transmission medium, such as a signal on a communications link. Various communications channels may be used, such as a local area network, wide area network, or a point-to-point dial-up connection can be used. One skilled in the art will appreciate that the drawing number search system can be implemented in other environments such as a client/server environment in which the drawing number search software executes on a client computer and accesses a database on a server computer that stores the drawing number data.

The drawing number search server includes an admin component 704, a web engine 706, a submission component 708, a search component 710, a database 712, and a user database 714. The admin component allows an administrator to perform administrative tasks such as adding or deleting users, modifying data in the database, or defining permissions. The web engine receives requests, such as HTTP requests, from user computers and invokes the appropriate component of the drawing number search system to service the request and provide responses, such as HTTP responses. The submission component coordinates the entry of the drawing number search requests. The database is used to store the drawing number information, including the generator type, shop order identification, part identifier, etc. associated with a drawing number. The database may be located within the drawing number search server, or may be alternatively in communication with the drawing number search server. The search component searches the database for a drawing number based on the input received by the submission component. The user database may contain an entry for each user authorized to use the drawing number search system. The user database may include a user name and password of each user for authentication and authorization purposes. Each user may have different levels of authority. For example, one user may have authority to only search for drawing numbers, while another user (e.g., an administrator) may have authority to modify the database (e.g., add new drawing numbers to the system).

One skilled in the art will recognize that the drawing number data may be entered into the database by a wide variety of means. One possibility would be for data to be transferred from legacy databases to the database, perhaps after a conversion of the data to an appropriate format. In another embodiment, the drawing number data may be manually entered. In yet another embodiment, drawing number server is in communication with a drawing number system that manages drawing numbers, and the drawing number data is automatically transferred from the drawing number system to the drawing number search system at regular intervals.

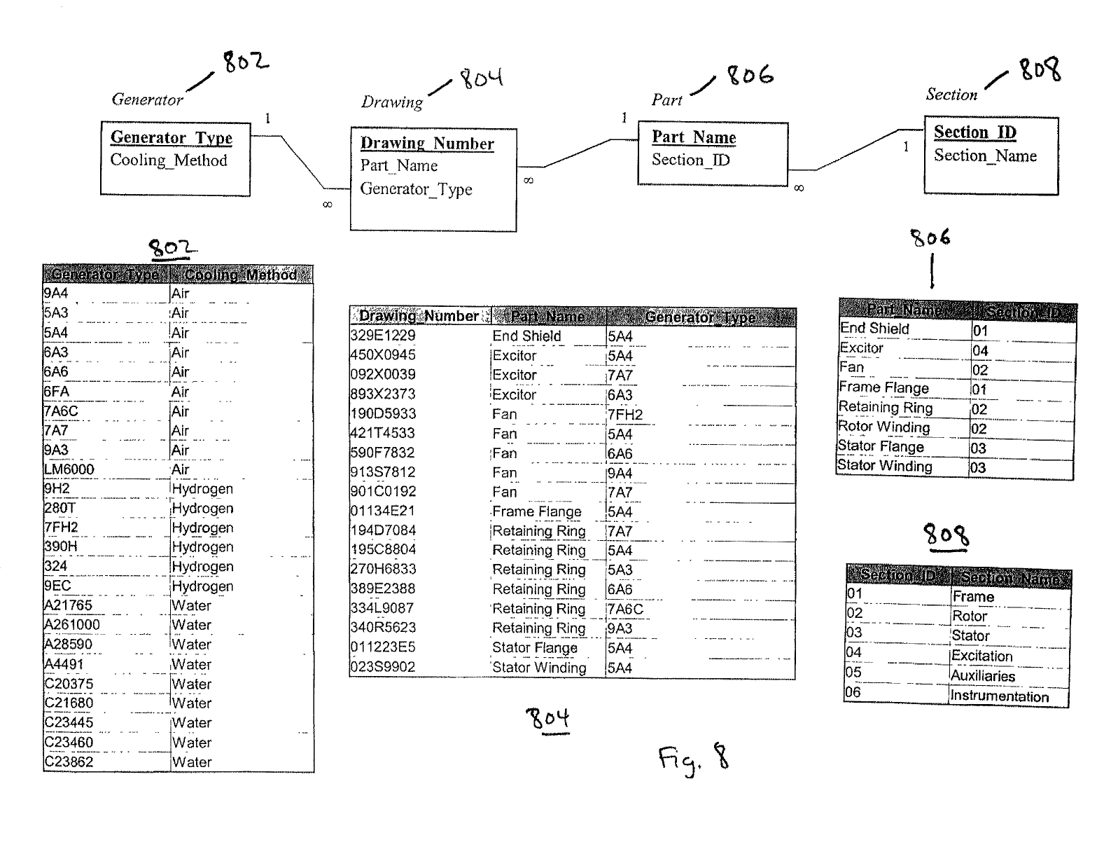

FIG. 8 illustrates a database schema for the drawing number search system in one embodiment. FIG. 8 includes a number of data structures or tables that represent a relational data model. One skilled in the art will appreciate that the database schema may be organized very differently depending on the design choice of the developers. FIG. 8 only represents one possible logical organization of the drawing number search sytem. The actual design of the database may take advantage of well-known techniques to meet the speed requirements, response time requirements, and other requirements of a particular implementation of the drawing number search system. In one embodiment, Microsoft Access or an Oracle database may be used. The database schema of FIG. 8 includes a generator_type table 802 with entries associating generator types with cooling methods. The generator types include the model names or other identification for types of generators, such as 9A4, 5A3, etc. The cooling methods include air-cooling, hyrdrogen-cooling, water-cooling, etc.

The generator_type table is linked to a drawing number table 804 with entries associating drawing numbers with part names and generator types. For each drawing number in the drawing number table, there is an associated part name and generator type. For example, drawing number “329E1229” is associated with the “end shield” part of the “5A4” generator type. This allows a search routine to determine a particular drawing number when the part name and generator type are known. In one embodiment, each drawing number is unique and identified with only one part name and generator type. In one alternative embodiment, a shop order is included in place of, or in addition to, the generator type in the drawing number table. In this embodiment, a particular drawing number may be found when the part type and shop order are known.

The drawing_number table is also linked to a part_name table 806, which entries associating part names with section identifications. The part_name table is also linked to a section_id table 808 with entries associating section identifications and section names. In the depicted embodiment, for example, the “end shield” is associated with a section identification of “01,” which is then associated with a section name of “frame,” as the end shield is part of the frame section of the generator.

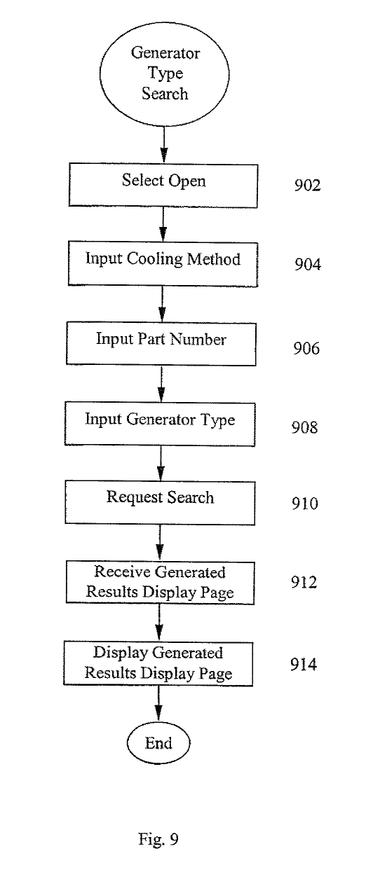

FIGS. 9-12 are flow diagrams illustrating processing of the drawing number search system in one embodiment. FIG. 9 is flow diagram illustrating a request to search by generator type in one embodiment. A user may search for a drawing number when the user knows the part name, cooling method, and the generator type. In block 902, the user selects the open button on the main display page. In block 904, the user inputs the cooling method, which may be air-cooling, water-cooling, hydrogen-cooling, or any other type of cooling method. In block 906, the user inputs the part name, which identifies the particular part associated with the desired drawing number. In one alternative embodiment, the user would input a part name or other part identification instead of a part name. In block 908, the user inputs the generator type, which is an identification of the particular generator associated with the drawing number that is desired. In one embodiment, the user selects the generator type from a list, and the contents of the list are based on the selected cooling method. For example, the generator type could be a model number. In block 910, the user optionally requests a search via a search button. In one alternative embodiment, the search begins automatically when the user has input all necessary information. The function continues in block 912, the function receives a generated results display page or other embodiment of the search results. In block 914, the generated results display page is displayed to the user and the function completes.

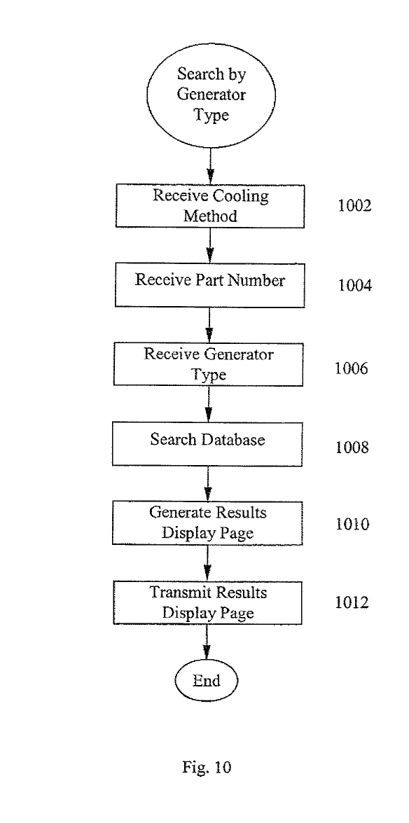

FIG. 10 is a flow diagram illustrating the processing of a request to search by generator type in one embodiment. This function processes the request made by the user to search for a drawing number by generator type, as described in relation to FIG. 9. In block 1002, the function receives the cooling method from the user. In block 1004, the function receives the part name from the user, while in block 1006 the function receives a generator type from the user. In block 1008, the function searches the database based on the part name and the generator type received from the user. The function continues in block 1010, the function generates a results display page or other embodiment of the search results. In block 1012, the generated results display page is transmitted to the user on a user computer and the function completes.

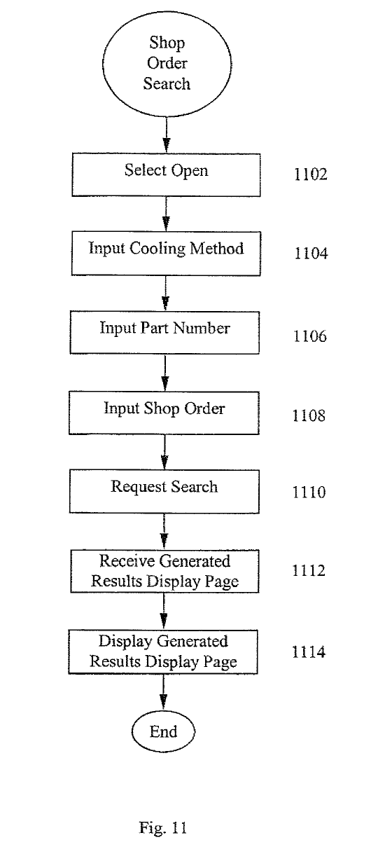

FIG. 11 is flow diagram illustrating a request to search by shop order identification in one embodiment. A user may search for a drawing number when the user knows the part name, cooling method, and the shop order identification. In block 1102, the user selects the open button on the main display page. In block 1104, the user inputs the cooling method, which may be air-cooling, water-cooling, hydrogen-cooling, or any other type of cooling method. In block 1106, the user inputs the part name, which identifies the particular part associated with the desired drawing number. In block 1108, the user inputs the shop order identification, which is an identification of the particular generator associated with the drawing number that is desired. In one embodiment, the user selects the shop order identification from a list, and the contents of the list are based on the selected cooling method. For example, the shop order identification could be a serial number or a special identification. In block 1110, the user optionally requests a search via a search button. In one alternative embodiment, the search begins automatically when the user has input all necessary information. The function continues in block 1112, the function receives a generated results display page or other embodiment of the search results. In block 1114, the generated results display page is displayed to the user and the function completes.

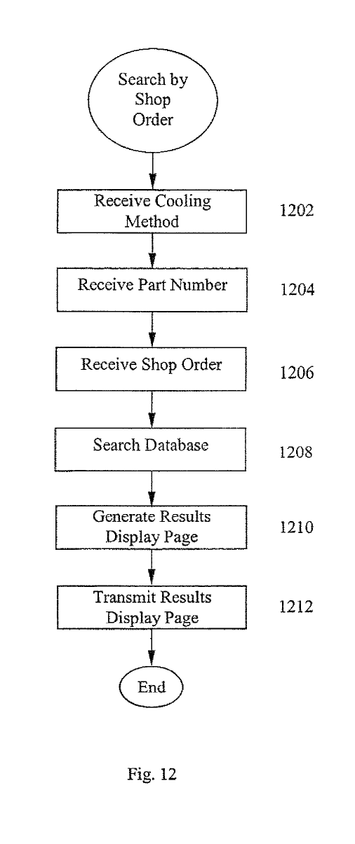

FIG. 12 is a flow diagram illustrating the processing of a request to search by shop order identification in one embodiment. This function processes the request made by the user to search for a drawing number by shop order identification, as described in relation to FIG. 11. In block 1202, the function receives the cooling method from the user. In block 1204, the function receives the part name from the user, while in block 1206 the function receives the shop order identification from the user. In block 1208, the function searches the database based on the part name and the shop order identification received from the user. The function continues in block 1210, the function generates a results display page or other embodiment of the search results. In block 1212, the generated results display page is transmitted to the user on a user computer and the function completes.

From the above description, it will be appreciated that although specific embodiments of the drawing number search system have been described for purposes of illustration, various modifications may be made without deviating from the scope of the invention. Accordingly, the invention is not limited except by the following claims.

1. A method in a computer system for searching for a drawing number related to a part in a generator, the method comprising:
receiving a part identification, the part identification being associated with the part in the generator;
receiving a generator identification;
searching for a drawing number, wherein the drawing number search is based on the part identification and the generator identification; and
providing an indication of the drawing number found in the search.

2. The method of claim 1 wherein the generator identification is a generator type.

3. The method of claim 1 wherein the generator identification is a shop order identification.

4. The method of claim 1 further comprising receiving a request to perform a search.

5. The method of claim 1 further comprising receiving a cooling method associated with the generator.

6. A drawing number search system comprising:
a generator receiving means for receiving information related to a generator, the generator information including a generator identification;
a part receiving means for receiving information related to a part, the part information including a part identification;
a searching means for searching for a drawing number based on the generator information and the part information; and
a results means for providing an indication of the drawing number found in the search.

7. A drawing number search system in a drawing number search computer comprising:
a submission component for receiving information related to a generator and for receiving information related to a part in a generator, the generator information including a generator identification, and the part information including a part identification;
a database for storing drawing numbers and drawing number information, the drawing number information including part information and generator information associated with individual drawing numbers;
a search component that determines a drawing number based on the generator information and the part information received by the submission component; and
an indication component that indicates the drawing number found in the search.

8. The system of claim 7 wherein the generator identification is a generator type.

9. The system of claim 7 wherein the generator identification is a shop order identification.

10. The system of claim 7 wherein the submission component receives a request from a user to perform a search.

11. A computer-readable medium whose contents cause a computer to search for a drawing number related to a part in a generator by a method comprising:
receiving a part identification, the part identification being associated with the part in the generator;
receiving a generator identification;
searching for a drawing number, wherein the drawing number search is based on the part identification and the generator identification; and
providing an indication of the drawing number found in the search.

12. The computer-readable medium of claim 11 wherein the generator identification is a generator type.

13. The computer-readable medium of claim 11 wherein the generator identification is a shop order identification.

14. The computer-readable medium of claim 11 further comprising receiving a request to perform a search from a user.

15. A method in a user computer for searching for a drawing number related to a part in a generator, the method comprising:
receiving a part identification from a user, the part identification being associated with the part in the generator;
receiving a generator identification from a user;
transmitting the part identification and the generator identification to a drawing number search server; and
receiving from the drawing number search server a drawing number associated with the part identification and the generator idnentification.

16. The method of claim 15 further comprising transmitting a request to search to the drawing number search server.

17. The method of claim 15 further comprising displaying the drawing number found in the search to a user.

18. The method of claim 15 wherein the generator identification is a generator type.

19. The method of claim 15 wherein the generator identification is a shop order identification.

20. The method of claim 15 wherein the drawing number search server determines a drawing number based on the part identification and generator identification received from the user computer.

21. The method of claim 15 further comprising receiving a cooling method associated with the generator from a user.

22. A computer-readable medium whose contents cause a user computer to request a search for a drawing number related to a part in a generator by a method comprising:
receiving a cooling method associated with the generator from a user;
receiving a part identification from a user, the part identification being associated with the part in the generator;
receiving an identification of the generator;
transmitting the part identification and the generator identification to a drawing number search server, wherein the drawing number search server determines a drawing number based on the part identification and generator identification received from the user computer;
receiving from the drawing number search server a drawing number associated with the part identification and the generator idnentification; and
displaying the drawing number found in the search to a user.

23. The computer-readable medium of claim 22 further comprising transmitting a request to search to the drawing number search server.

24. The computer-readable medium of claim 22 wherein the generator identification is a generator type.

25. The computer-readable medium of claim 22 wherein the generator identification is a shop order identification.

26. A computer-readable medium containing a data structure for use by a drawing number search system, the data structure comprising:
an indication of a generator identification, wherein the generator identification is a generator type or a shop order identification; and
an indication of a part identification, wherein the part identification is associated with a part in the generator.

27. The computer-readable medium of claim 26 further comprising an indication of a drawing number, the drawing number being associated with the generator identification and the part identification.
